(19) United States
(12) Patent Application Publication
(10) Pub. No.: US 2021/0296723 A1
(43) Pub. Date: Sep. 23, 2021

(54) ELECTRONIC APPARATUS AND BATTERY MODULE

(71) Applicant: CANON KABUSHIKI KAISHA, Tokyo (JP)

(72) Inventor: Yohei Yamada, Tokyo (JP)

(21) Appl. No.: 17/204,476

(22) Filed: Mar. 17, 2021

(30) Foreign Application Priority Data
Mar. 19, 2020 (JP) 2020-048534

(51) Int. Cl. H01M 50/136; H01M 50/238; H01M 50/552; H01M 50/298

(52) U.S. Cl. CPC H01M 50/136; H01M 50/298; H01M 50/552; H01M 50/238

(57) ABSTRACT

Art electronic apparatus includes a substrate having flexibility and including a base material made of a thin film material, a plurality of electric devices arranged on one surface of the base material and including a set of terminal electrodes, a joint configured to electrically connect the terminal electrodes and the substrate via a conductive joining member, a reinforcer provided on a surface of the base material opposite to a mount surface of each of the plurality of electric devices, and configured to reinforce a mount area of each electric device, and a weakener configured to weaken a non-mount area in which each electric device is not mounted. The reinforcer includes a reinforcing pattern made of a conductive material. The weakener has an opening that penetrates at least part of the substrate and the base material.

### BACKGROUND OF THE INVENTION

### Field of the Invention

The present invention relates to an electronic apparatus and a battery module.

### Description of the Related Art

Conventionally, as the electronic apparatuses become more sophisticated, the number of electric devices forming electric circuits and substrates mounted with them tends to increase. As the electronic apparatuses become compact and their designs diversify, substrates having flexibility or flexible substrates such as a flexible printed circuits (board or substrate) (FPC) are used for a structure for installing an electric circuit in a small space inside the electronic apparatus.

In recent years, space saving and high safety have been demanded for electronic apparatuses worn and used by humans, such as wearable devices. Accordingly, an electronic apparatuses equipped with an all-solid-state battery that can be reflow-soldered on the substrate have been proposed.

PCT international Publication No. WO2016/092888 discloses a freely pliable battery module that divides a desired battery capacity into a plurality of thin or compact all-solid-state batteries and mounts them on a bendable substrate. Since this structure can use the space where it was difficult to mount the battery, for the battery space, the electronic apparatus can be expected to be compact. In addition, high safety can be ensured with the all-solid-state battery serving as a power source for the electronic apparatus.

However, the battery module disclosed in PCT International Publication No. WO2016/092888 may cause stress at a connector that connects the all-solid-state battery and wires in a state where the pliable substrate is bended, weaken the strength of the connector due to the stress, and deteriorate the performance due to poor connections.

### SUMMARY OF THE INVENTION

The present invention provides an electronic apparatus and a battery module, each of which can reduce stress generated at a connector between an electric device and a substrate in a state where a flexible substrate is bent.

An electronic apparatus according to one aspect of the present invention includes a substrate having flexibility and including a base material made of a thin film material, a plurality of electric devices arranged on one surface of the base material and including a set of terminal electrodes, a joint configured to electrically connect the terminal electrodes and the substrate via a conductive joining member, a reinforcer provided on a surface of the base material opposite to a mount surface of each of the plurality of electric devices, and configured to reinforce a mount area of each electric device, and a weakener configured to weaken a non-mount area in which each electric device is not mounted. The reinforcer includes a reinforcing pattern made of a conductive material. The weakener has an opening that penetrates at least part of the substrate and the base material.

A battery module according to another aspect of the present invention includes a plurality of all-solid-state batteries each made by laminating a positive electroactive material, a solid electrolyte, and a negative electroactive material, a substrate having flexibility, mounted with the plurality of all-solid-state batteries on one surface, and curved with a predetermined curvature, a retainer configured to house and retain the substrate, and joining terminals extending from both ends of the retainer.

Further features of the present invention will become apparent from the following description of exemplary embodiments with reference to the attached drawings.

### BRIEF DESCRIPTION OF THE DRAWINGS

FIGS. 1A and 1B are external perspective views of a camera according to each embodiment.

FIG. 2 is a block diagram of the camera according to each embodiment.

FIGS. 3A and 3B are perspective views of an internal structure of the camera according to each embodiment.

FIGS. 4A and 4B are structural diagrams of the all-solid-state battery according to each embodiment.

FIG. 5 is a structural diagram of FPC according to a first embodiment

FIGS. 6A to 6C are sectional views of the FPC according to the first embodiment.

FIG. 7 is a structural diagram of FPC according to a second embodiment.

FIG. 8 is a structural diagram of a retention case according to a third embodiment.

FIGS. 9A and 9B are configuration diagrams of FPC and a wearable device according to a fourth embodiment.

### DESCRIPTION OF THE EMBODIMENTS

Referring now to the accompanying drawings, a detailed description will be given of embodiments according to the present invention.

### First Embodiment

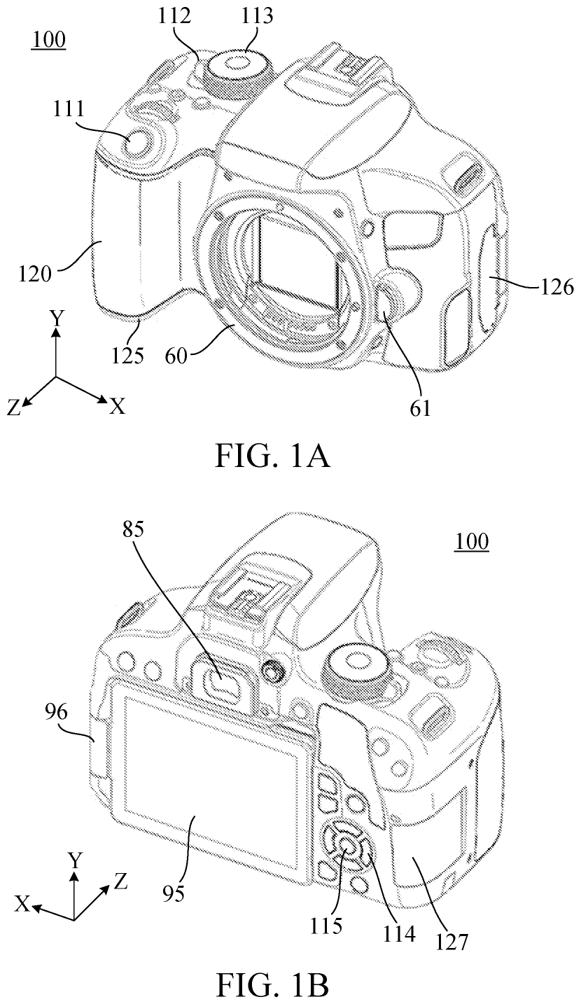

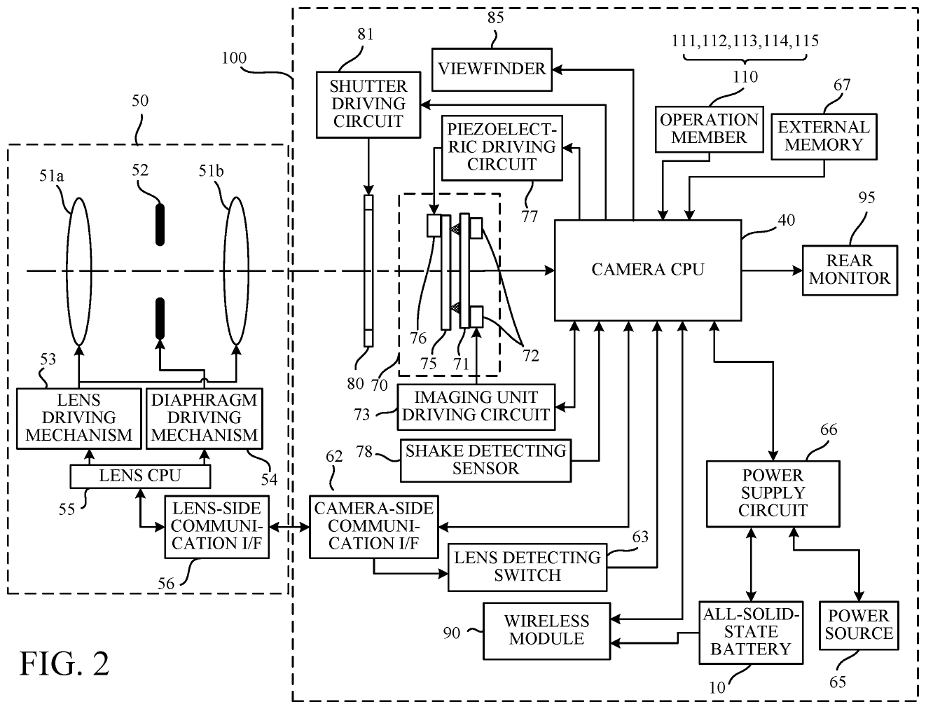

Referring now to FIGS. 1A, 1B, and 2, a description will be given of a camera (image pickup apparatus) 100 according to a first embodiment of the present invention. FIG. 1A is an external perspective view of the camera 100, viewed from the front side. FIG. 1B is an external perspective view of the camera 100, viewed from the rear side. FIG. 2 is a block diagram of the camera 100.

In FIGS. 1A, 1B, and 2, reference numeral 100 denotes a camera (lens interchangeable type digital camera) as an electronic apparatus. Reference numeral 50 denotes an imaging lens (interchangeable lens), which is attachable to and detachable from a mount opening 60 on a front surface of the camera 100 when a lens attachment/detachment button 61 is pressed. A camera system (imaging system) includes the camera 100 and the imaging lens 50.

The camera 100 and the imaging lens 50 are electrically connected by a camera-side communication interface (I/F) 62 and a lens-side communication I/F 56, and can communicate various signals with each other. The power is supplied from the camera 100 to the imaging lens 50. A lens detecting switch 63 of the camera 100 determines whether or not the camera 100 and the imaging lens 50 can communicate with each other via the camera-side communication I/F 62 and the lens-side communication I/F 56. The lens detecting switch 63 can identify the type of the imaging lens 50 mounted on the camera 100. Reference numerals 51a and 51b denote lenses including a plurality of lenses, such as a focus lens and a zoom lens. Reference numeral 52 denotes a diaphragm (aperture stop) for adjusting an aperture amount. Reference numeral 53 denotes a lens driving mechanism for driving the lenses 51a and 51b for focusing and zooming. Reference numeral 54 denotes a diaphragm driving mechanism for driving the diaphragm 52 and for controlling an aperture value (F-number). Reference numeral 55 denotes a lens CPU that performs signal processing in the imaging lens 50.

Reference numeral 40 denotes a camera CPU having a function of a central processing unit that controls the operation of each element of the camera 100. The camera CPU 40 will be simply referred to as the CPU 40 hereinafter. Reference numeral 65 denotes a power source for supplying electric power to each element in the camera 100. The power supply 65 is a secondary battery including a battery pack that is attachable to and detachable from the camera 100. Reference numeral 66 denotes a power supply circuit that converts the voltage of the power supply 65 into a voltage required for the operation of each element in the camera 100. Reference numeral 10 denotes an all-solid-state battery serving as an electric device (or element). The all-solid-state battery 10 is a secondary battery having a reflow-soldered structure. In this embodiment, the all-solid-state battery 10 is charged by the power supply circuit 66 to supply power to a wireless module 90. The configuration of the all-solid-state battery 10 will be described in detail later. The present invention is also applicable to electric devices other than the all-solid-state battery 10.

Reference numeral 71 denotes an image sensor (image pickup element) including a CMOS sensor or a CCD sensor that captures and photoelectrically converts an imaging luminous flux taken from the imaging lens 50, and has an electronic shutter function. Reference numeral 80 denotes a shutter including a focal plane shutter, which controls an amount of the incident imaging luminous flux by exposing and shielding the image sensor 71. Reference numeral 81 denotes a shutter driving circuit that opens and closes a shutter curtain (not shown) of the shutter 80, and can shift and hold the shutter curtain (not shown) in an open state that exposes the image sensor 71 and a closed state that shields the image sensor 71.

Reference numeral 75 denotes a rectangular optical low-pass filter disposed in front of the image sensor 71 and made of a material such as quartz. Reference numeral 76 denotes a piezoelectric element adhered to and held on the surface of the optical low-pass filter 75 and configured to vibrate in a wavy shape in the Z-axis direction (optical axis direction of the camera 100) when receiving the voltage. Reference numeral 77 denotes a piezoelectric element driving circuit that controls energization of the piezoelectric element 76. The piezoelectric element 76 and the piezoelectric element driving circuit 77 are electrically connected to each other via FPC for a piezoelectric element (not shown). By controlling the energization of the piezoelectric element 76 by the piezoelectric element driving circuit 77, the optical low-pass filter 75 can vibrate in a wavy shape in the Z-axis direction (optical axis direction of the camera 100) in a plurality of vibration modes having different orders. Thereby, dust adhering to the surface of the optical low-pass filter 75 can be removed.

Reference numeral 78 denotes a shake detecting sensor that detects a shake amount of the camera 100 due to camera shake or the like. The shake detecting sensor 78 includes an angular velocity sensor, periodically detects an angular velocity representing a moving amount of the camera 100, converts it into an electric signal, and outputs it. Reference numeral 72 denotes an imaging unit driving mechanism 72 includes a drive coil (not shown), a permanent magnet (not shown), and a position detecting sensor (not shown) for driving the image sensor 71 on a plane orthogonal to the optical axis of the camera 100. Reference numeral 73 denotes an imaging unit driving circuit that is electrically connected to the imaging unit driving mechanism 72 via FTC for an imaging unit driving mechanism (not shown) to control the energization of the imaging unit driving mechanism 72. A constituent unit including the image sensor 71, the optical low-pass filter 75, the piezoelectric element 76, and the imaging unit driving mechanism 72 will be referred to as an imaging unit 70. Image blurs can be corrected by driving the imaging unit 70 in a direction of canceling the shake of the camera 100 according to the detection result of the shake detecting sensor 78.

Reference numeral 67 denotes an external memory for recording captured images, which includes a semiconductor memory card or the like that is attachable to and detachable from the camera 100. Reference numeral 85 denotes a viewfinder provided on upper part of the back surface of the camera 100 and includes an electronic viewfinder (EVF) for displaying a through-image captured by the image sensor 71 and displaying settings of the camera 100. Reference numeral 95 denotes a rear monitor provided on the back surface of the camera, which includes a liquid crystal display for displaying a through-image captured by the image sensor 71, setting information of the camera 100, and a captured image. The rear monitor 95 has a touch panel function. Reference numeral 96 denotes a variable angle hinge including a biaxial hinge that holds the rear monitor 95 rotatably around the Y-axis and the X-axis relative to the camera 100. Reference numeral 90 denotes a wireless module that performs wireless communications with an external device (not shown). In this embodiment, the wireless module 90 has a wireless communication function. The wireless module 90 has a so-called GPS logger function for receiving GPS information at predetermined time intervals and for keeping a record of the received GPS information. The wireless module 90 can operate with the electric power of the power source 65 and the electric power of the all-solid-state battery 10, and even when the power source 65 is removed from the camera 100 or the camera 100 is powered off, the wireless module 90 can be operated.

Provided on the top surface and the rear surface of the camera 100 is an operation member 110 including a plurality of buttons and dials for the user to set the camera 100 and perform an imaging operation. More specifically, the operation member includes a shutter button 111 for performing an imaging operation, a power switch 112 for switching the power between turning on and turning off, a mode dial 113 for switching the imaging mode, a selection button 114 for selecting various settings, and a setting button 115 for determining various settings.

Reference numeral 120 denotes a grip provided on the front side of one end of the camera 100, and formed in a curved shape protruding toward the front side so that the user can hook the fingers (mainly the middle finger, ring finger, and little finger) to grip the camera 100. Reference numeral 125 denotes a battery lid provided on the lower surface side of the grip 120, one end of which is pivotally supported by the camera 100, and the other end of which is rotatable between a closed state in which it is engaged with the camera 100 and an open state in which it is disengaged from the camera 100. Reference numeral 126 denotes an lid provided at the opposite end of the grip 120 and configured to open and close between an open state for exposing an external I/F 152 described later and a closed state for shielding the external I/F 152. Reference numeral 127 denotes a media lid configured to open and close between an open state that exposes a housing (not shown) of the external memory 67 and a closed state that shields the housing part (not shown).

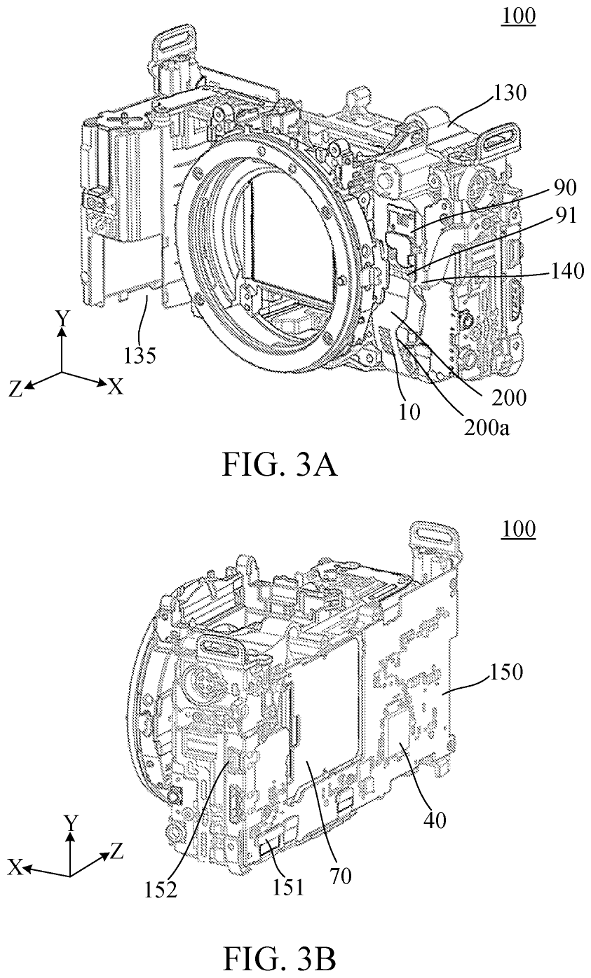

Referring now to FIGS. 3A and 3B, a description will be given of an internal structure of the camera 100. FIG. 3A is a perspective view of the internal structure of the camera 100, viewed from the front side. FIG. 3B is a perspective view of the internal structure of the camera 100, viewed from the rear side.

In FIGS. 3A and 3B, reference numeral 130 denotes a body formed by injection molding of resin or the like to form a framework to which each element of the camera 100 is attached. Reference numeral 135 denotes a battery chamber provided to part of the body 130 and for housing a power source 65 attachable to and detachable from the camera 100. The battery chamber 135 is exposed by opening the battery lid 125, and allows the power supply 65 to be attached and detached. The battery compartment 135 has an electric contact (not shown) for electrically connected to the power supply 65 when the power supply 65 is attached.

Reference numeral 150 denotes a circuit board attached to the rear side of the body 130 and including a PWB (Printed Wired Board). Various electronic components constituting an electric circuit for controlling the operation of the camera 100 such as the CPU 40 are mounted on the circuit board 150 by reflow soldering or the like. The external VP 152 for connecting to the external device is mounted on the circuit board 150. In this embodiment, the external I/F 152 is a general-purpose external connection terminal such as a USB connector.

Reference numeral 140 denotes an attachment member made by press working with sheet metal etc. for attaching the wireless module 90 to the body 130. The wireless module 90 is attached to the front side of the body 130 via the attachment member 140 on the opposite side of the grip 120, and similar to the circuit board 150, the electric circuit and antenna pattern constituting the wireless function is provided on the substrate formed by the PWB. The wireless module 90 is electrically connected to the circuit board 150 via FPC 200. The wireless module 90 including a wireless side connector 91 for fixing and holding one end of the FPC 200 and an electric connection with the FPC 200. On the other hand, the circuit board 150 is mounted with a circuit board side connector 151 for fixing and holding one end of the FPC 200 opposite to the wireless side connector 91 and an electric connection with the FPC 200. As described above, the wireless module 90 is attached to the side opposite to the grip 120 and to the front side of the body 130. Thereby, good wireless performance can be obtained because the wireless module 90 is not shielded when the user holds the grip 120 to carry the camera 100 or take a picture.

The FPC 200 has a structure in which an insulating material such as polyimide is used as the base material, a circuit is formed on the surface of the base material with copper foil or the like, and a coyerlay made of polyimide or the like is laminated on the outermost surface. The FPC 200 has flexibility and can be disposed in a bent shape along the shape of the electronic apparatus, or can be repeatedly bent. In this embodiment, the FPC 200 adopts a generally known double-sided structure. Reference numeral 200a denotes a curved part having a curved surface shape that occurs when the FPC 200 is incorporated into the camera 100. A plurality of all-solid-state batteries 10 are mounted on the curved part 200a. The structure of the FPC 200 will be described in detail later.

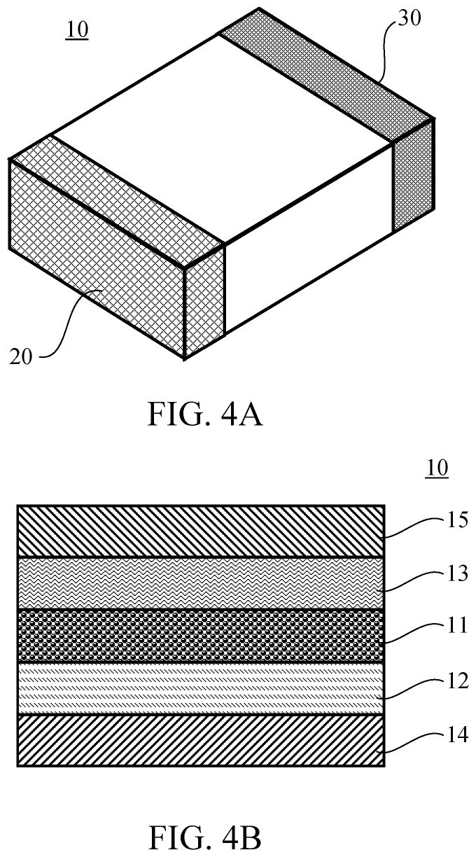

Referring now to FIGS. 4A and 4B, a description will be given of the all-solid-state battery 10 according to this embodiment. FIG. 4A is an external view of the all-solid-state battery 10. In FIG. 4A, the all-solid-state battery 10 serving as an electric device is a secondary battery containing a solid electrolyte, and has a positive electrode terminal 20 and a negative electrode terminal 30 at both ends. The positive, electrode terminal 20 and the negative electrode terminal 30 are formed of metal plating such as copper (Cu), nickel (Ni), and tin (Sn), and can be soldered by a reflow soldering method or the like. In this embodiment, the all-solid-state battery 10 has a substantially rectangular parallelepiped outer shape having a side of several mm to several tens of mm, and an exterior material is made of a material such as ceramics or resin.

FIG. 4B is an internal structure diagram of the all-solid-state battery 10. In FIG. 4B, reference numeral 11 denotes a solid electrolyte layer formed of a solid electrolyte made of a lithium ion conductor such as oxide glass or oxide glass ceramics. Reference numeral 12 denotes a positive electroactive material layer made of a positive electroactive material including a lithium compound and a solid electrolyte composed of a lithium ion conductor. Reference numeral 13 denotes a negative electroactive material layer made of a negative electroactive material including a carbon material such as graphite and a solid electrolyte made of a lithium ion conductor. Reference numeral 14 denotes a positive electrode current collector layer made of a current collector including metal such as aluminum (Al), copper (Cu), nickel (Ni) or an alloy containing these metals. Reference numeral 15 denotes a negative electrode current collector layer made of a current collector including a metal such as aluminum (Al), copper (Cu), nickel (Ni) or an alloy containing these. metals.

The all-solid-state battery 10 is made by internally laminating the solid electrolyte layer 11, the positive electroactive material layer 12, the negative electroactive material layer 13, the positive electrode current collector layer 14, and the negative electrode current collector layer 15. The method of laminating the solid electrolyte layer 11, the positive electroactive material layer 12, the negative electroactive material layer 13, the positive electrode current collector layer 14, and the negative electrode current collector layer 15 inside the all-solid-state battery 10 is not particularly limited and various known techniques can be used. For example, like a so-called bulk type all-solid-state battery, materials constituting each layer are made into fine particles and laminated by a method such as coating or printing. Alternatively, like a so-called thin film type all-solid-state battery, thin films constituting each layer are formed and laminated by a vapor phase method or the like.

The all-solid-state battery 10 according to this embodiment may be a secondary battery that includes the solid electrolyte layer 11, the positive electroactive material layer 12, and the negative electroactive material layer 13 in its inside, and positive electrode terminals 20 and negative electrode terminals 30 that can be soldered to both ends. Therefore, various known techniques can be used while the structure and materials are not limited.

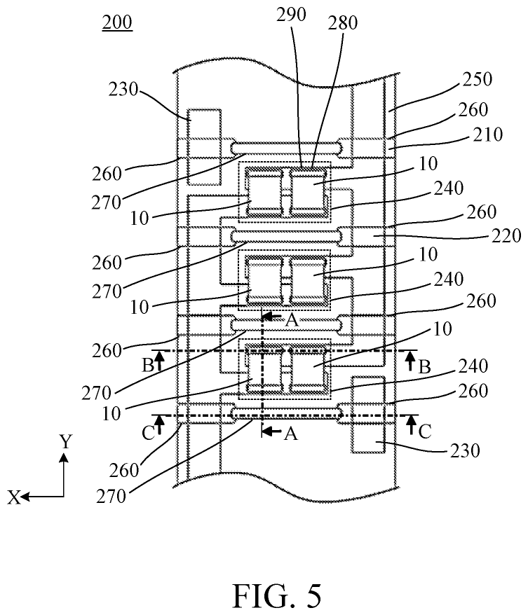

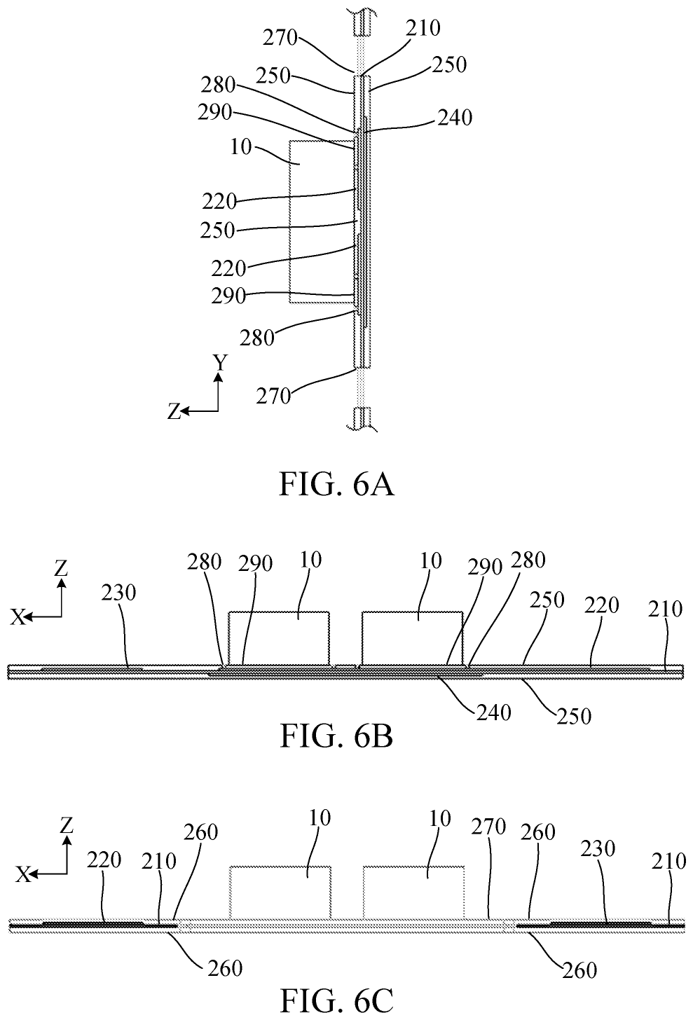

Referring now to FIGS. 5 and 6A to 6C, a description will be given of the FPC 200 according to this embodiment. FIG. 5 is a structural diagram of the FPC 200, and is a partially enlarged of the curved part 200a. FIG. 5 illustrates a pre-assembly plane state of the FPC 200, rather than a curved state of the FPC 200 incorporated into the camera 100. FIGS. 6A to 6C are sectional views of the FPC 200. FIG. 6A is a sectional view taken along a line A-A in FIG. 5. FIG. 6B is a sectional view taken along a line B-B in FIG. 5. FIG. 6C is a sectional taken along a line C-C in FIG. 5.

In FIGS. 5 and 6A to 6C, a plurality of all-solid-state batteries 10 are mounted on the FPC 200. Reference numeral 210 denotes a base material made of an insulating material such as polyimide. In this embodiment, the base material 210 has a thickness of 35 μm. Reference numeral 220 denotes a power supply wiring pattern made of a conductive material such as copper foil. The power supply wiring pattern 220 is provided on the surface of the base material 210 on the side on which the all-solid-state battery 10 is mounted, and is attached and fixed to the base material 210 with an adhesive (not shown). The power supply wiring pattern 220 is electrically connected to the positive electrode terminal 20 and the negative electrode terminal 30 so that the all-solid state batteries 10 are connected in parallel. In this embodiment, the power supply wiring pattern 220 has a thickness of 35 μm. In this embodiment, the directions of the positive electrode terminal 20 and the negative electrode terminal 30 in the all-solid-state battery 10 are arranged in parallel with a predetermined direction, that is, a curving or bending direction (Y direction in FIG. 5).

As described above, providing the all-solid-state batteries 10 in parallel connection can increase the capacity of the power supply for operating the wireless module 90. Therefore, a long-time wireless communication can be made even when the camera 100 is powered off, which is convenient for the user. In this embodiment, the all-solid-state batteries 10 are connected in parallel, but they may be connected in series. For example, as described above, the camera 100 has a dustproof function configured to wavily vibrate the optical low-pass filter 75 in the Z-axis direction (optical axis direction of the camera 100) in a plurality of vibration modes having different orders by controlling energization to the piezoelectric element 76 through the piezoelectric device driving circuit 77. A high voltage is required for the dustproof function to operate. On the other hand, a high battery capacity is not required because it is not a frequently used function. Hence, when the all-solid-state battery 10 is used as the power source for the dustproof function, a desired voltage can be obtained by the series connection. As described above, the all-solid-state battery 10 can be disposed in series or parallel connection according to the function to be operated, and is suitable as a power source for the electronic apparatus.

Reference numeral 230 denotes a dummy pattern (balancer, twist suppresser) made of a conductive material such as copper foil. The dummy pattern 230 is provided on the surface of the base material 210 on the side on which the all-solid-state battery 10 is mounted, and is attached and fixed to the base material 210 with an adhesive (not shown). The dummy pattern 230 is separated from the power supply wiring pattern 220 and connected to a GND (ground) pattern (not shown). In this embodiment, the dummy pattern 230 has a thickness of 35 μm.

Reference numeral 240 denotes a reinforcing pattern (reinforcer or deformation suppresser) made of a conductive material such as copper foil. The reinforcing pattern 240 is provided on a surface opposite to the surface on which the all-solid-state battery 10 is mounted with respect to the intervening base material 210, and is attached and fixed to the base material 210 with an adhesive (not shown). The reinforcer reinforces a mount area in which the all-solid-state battery 10 is mounted, and the deformation suppresser suppresses a deformation of the mount area. The reinforcing pattern 240 has a substantially rectangular shape so as to surround the area where the all-solid-state battery 10 is mounted. In this embodiment, the reinforcing pattern 240 has a thickness of 35 μm.

Reference numeral 250 is a coverlay made of an insulating material such as polyimide. The coverlay 250 is provided on both sides of the base material 210, and is attached and fixed to the base material 210, the power supply wiring pattern 220, the dummy pattern 230, and the reinforcing pattern 240 with an adhesive (not shown). In this embodiment, the coverlay 250 has a thickness of 45 μm. Reference numeral 260 denotes a coverlay opening (weakener or deformation promoter) in which the coverlay 250 is partially opened to expose the base material 210, the power supply wiring pattern 220, and the dummy pattern 230. Reference numeral 270 is a slit (weakener or deformation promoter) formed by a substantially rectangular opening penetrating the coverlay 250 and the base material 210. The weakener weakens a non-mount area in which the all-solid-state battery 10 is not mounted, and the deformation promoter promotes a deformation of the non-mount area.

Reference numeral 280 denotes a joint provided at positions corresponding to the positive electrode terminal 20 and the negative electrode terminal 30 of the all-solid-state battery 10 and configured to open part of the coverlay 250 and expose the power supply wiring pattern 220. Reference numeral 290 is a joining member made of a conductive material such as solder. The joining member 290 is configured to electrically connect the all-solid-state batteries 10 and the power supply wiring pattern 220 to each other.

Referring now to FIGS. 5 and 6A to 6C, a description will be given of a stress relief function according to this embodiment. In FIGS. 5 and 6A to 6C, the reinforcing pattern 240 has a substantially rectangular shape so as to surround the area where the all-solid-state battery 10 is mounted. The outer shape of the reinforcing pattern 240 is located outside the joint 280. Thereby, the rigidity of the area where the all-solid-state battery 10 is mounted can be increased. When the FPC 200 is bent, the area where the all-solid-state battery 10 is mounted can be restrained from deforming, and the stress generated in the joint 280, the joining member 290, and the all-solid-state battery 10 can be relieved. In this embodiment, the reinforcing pattern 240 increases the rigidity of the area where the all-solid-state battery 10 is mounted, but a reinforcing plate made of glass epoxy or the like may be provided. For example, even if a pattern made of copper foil or the like is not provided on the surface opposite to the surface with respect to the base material 210 on which the all-solid-state battery 10 is mounted, the rigidity of the area on which the all-solid-state battery 10 is mounted can be made higher.

The slits 270 are provided on both sides of the area where the all-solid-state battery 10 is mounted, in the curving direction (Y direction in FIG. 5). The slit 270 is larger than the reinforcing pattern 240 in the direction (X direction in FIG. 5) orthogonal to the curving direction. Thereby, the rigidity on both sides of the area where the all-solid-state battery 10 is mounted, in the curving direction (Y direction in FIG. 5) can be made lower. That is, when the FPC 200 is bent, good flexibility can be obtained by promoting deformations on both sides of the area where the all-solid-state, battery 10 is mounted, in the curving direction (Y direction in FIG. 5). The stress generated in the joint 280, the joining member 290, and the all-solid-state battery 10 can be relieved.

The slit 270 is distant from the reinforcing pattern 240 by a predetermined distance in the curving direction (Y direction in FIG. 5). Thereby, the wiring width of the power supply wiring pattern 220 can be made wide. That is, a large current can flow, and heat generation due to wiring resistance can be suppressed. In this embodiment, the slit 270 is formed by a substantially rectangular opening penetrating the coverlay 250 and the base material 210, but may be formed by combining a plurality of holes, cuts, and coverlay openings. For example, the optimum configuration can be selected in consideration of the curvature in the curving direction and the space in the electronic apparatus.

The coverlay openings 260 are provided on both sides of the slit 270 in the direction (X direction in FIG. 5) orthogonal to the curving direction. The coverlay opening 260 is formed by opening the coverlay 250 provided on both sides of the base material 210. Thereby, the rigidity on both sides in the curving direction (Y direction in FIG. 5) can be made lower than that of the area where the all-solid-state battery 10 is mounted. That is, when the FPC 200 is bent, good flexibility can be obtained by promoting deformations on both sides of the area where the all-solid-state battery 10 is mounted, in the curving direction (Y direction in FIG. 5).

When the power supply wiring pattern 220 and the dummy pattern 230 are exposed by the coverlay opening 260, a surface treatment such as gold plating may be made. Thereby, the deterioration, corrosion, and the like can be prevented. In this embodiment, the coverlay opening 260 has a structure formed by opening the coverlay 250 provided on both sides of the base material 210, but it may be formed by opening the coverlay 250 on one surface of the base material 210. More specifically, it is formed by opening the coverlay 250 on the surface opposite to the surface on which the power supply wiring pattern 220 is provided. Thereby, the power supply wiring pattern 220 and the dummy pattern 230 can be protected with no surface treatment such as plating, so that the deterioration, corrosion, and the like can be prevented.

In this embodiment, the coverlay opening 260 is formed by opening the coverlay 250 provided on both sides of the base material 210. At this time, the coverlay opening 260 may be formed by openings having substantially the same shape as the coverlay 250 provided on both sides, or may be formed by openings having different shapes. Since it is possible to obtain high flexibility by forming the openings having substantially the same shape, it is suitable for the FPC 200 having a large curvature when it is bent. By forming the openings having different shapes, the positions of the opening ends can be made different, and the stress concentration at the opening ends when the FPC 200 is bent can be avoided. As described above, the optimum configuration can be selected in consideration of the curvature in the curving direction and the flexibility of the FPC 200.

The dummy pattern 230 is provided at a position corresponding to the coverlay opening 260 in which the power supply wiring pattern 220 is not provided. The dummy pattern 230 is substantially as large as the power supply wiring pattern 220 in the direction (X direction in FIG. 5) orthogonal to the curving direction. Thereby, the rigidity of the area of the coverlay opening 260 can be made substantially the same. That is, the FPC 200 when bent can be restrained from twisting, and the good flexibility can be obtained. Thus, the twist suppressor suppresses a twist of the FPC 200.

In this embodiment, the FPC 200 includes the base material 210 made of a thin film material and has flexibility. The plurality of all-solid-state batteries 10 are arranged on one surface of the base material 210 and include a set of terminal electrodes (positive electrode terminal 20 and negative electrode terminal 30). The joint 280 electrically connects the terminal electrodes and the FPC 200 to each other via the conductive joining member 290. The reinforcer is provided on the surface of the base material 210 opposite to the mount surface of each of the plurality of all-solid-state batteries 10, and configured to reinforce a mount area of the all-solid-state battery 10. The weakener is configured to weaken a non-mount area in which the all-solid-state battery 10 is not mounted. The weakener may be provided, in the curving direction, at both ends of the mount area of the plurality of all-solid-state batteries 10 in the FPC 200.

The FPC 200 may have the curved part 200a curved with a predetermined curvature in an assembled state into the electronic apparatus such as the camera 100 or a use state. The plurality of electric devices may be arranged at predetermined intervals along the curving direction, and the reinforcer and the weakener may be alternated along the curving direction. The reinforcer may be a reinforcing pattern 240 made of a conductive material, and the weakener may be an opening (coverlay opening 260 and slit 270) penetrating at least part of the FPC 200 and the base material 210. The all-solid-state battery 10 may be made by laminating the positive electroactive material, the solid electrolyte, and the negative electroactive material, The reinforcer may be larger than the joint in the direction orthogonal to the curving direction, the weakener may be distant from the joint by a predetermined distance, and larger than the reinforcer in the direction orthogonal to the curving direction.

The reinforcer may include a plurality of deformation suppressers. The deformation suppressor is provided for a corresponding one of the plurality of all-solid-state batteries 10, and suppresses a deformation of the mount area. The weakener may include a plurality of deformation promoters. The deformation promotor is provided for a corresponding one of the plurality of all-solid-state batteries 10, and promotes a deformation of the non-mount area. The plurality of deformation suppressers and the plurality of deformation promoters may be alternated along the bending direction. A wiring pattern (power supply wiring pattern 220) electrically connected to at least one of the plurality of all-solid-state batteries 10 is provided on the surface of at least one of the plurality of deformation promoters. A twist suppresser (dummy pattern 230) is provided on the surface of one of the plurality of deformation promoters, which has no power source wiring pattern 220. The twist suppresser is divided from the power source wiring pattern 220, as large as the power source wiring pattern 220 in the direction orthogonal to the curving direction, and suppresses a twist of the FPC 200.

As described above, this embodiment provides the reinforcing pattern 240 to the area where the all-solid-state batteries 10 are mounted to increase the rigidity. The slits 270 are provided on both sides of the area where the all-solid-state batteries 10 are mounted, in the curving direction (Y direction in FIG. 5), and the coverlay openings 260 are provided on both sides of the slits 270 in the direction (X direction in FIG. 5) orthogonal to the curving direction, so as to reduce the rigidity. That is, when the FPC 200 is bent, the area where the all-solid-state batteries 10 are mounted can be restrained from deforming, and the deformations can be promoted on both sides of the area where the all-solid-state batteries 10 are mounted, in the curving direction (Y direction in FIG. 5). This structure can provide good flexibility and relieve the stress generated in the joint 280, the joining member 290, and the all-solid-state batteries 10.

### Second Embodiment

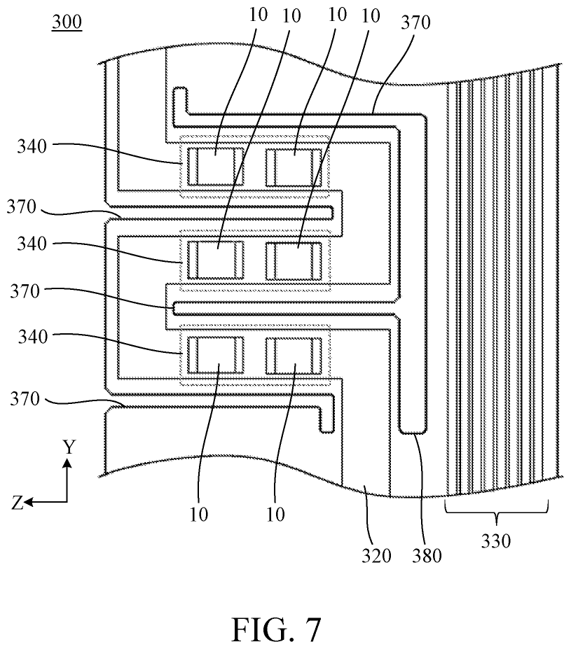

Referring now to FIG. 7, a description will be given of FPC 300 according to a second embodiment of the present invention. For a simple description, only the parts different from those of the first embodiment will be described. FIG. 7 is a structural diagram of the FPC 300 in this embodiment.

In FIG. 7, a plurality of all-solid-state batteries 10 are mounted on the FPC 300. Reference numeral 320 denotes a power supply wiring pattern (first wiring pattern) made of a conductive material such as copper foil. The power supply wiring pattern 320 is electrically connected to the positive electrode terminal 20 and the negative electrode terminal 30 so that the all-solid-state batteries 10 are connected in series. The power supply wiring pattern 320 is formed in a substantially meandering shape in the area where the all-solid-state batteries 10 are mounted. In this embodiment, the direction of the positive electrode terminal 20 and the negative electrode terminal 30 of the all-solid-state batteries 10 is the direction (X direction in FIG. 7) orthogonal to the curving direction.

Reference numeral 330 denotes a signal wiring pattern (second wiring pattern) made of a conductive material such as copper foil. In this embodiment, the signal wiring pattern 330 is a wiring pattern for transmitting a digital signal. A plurality of signal wiring patterns 330 are formed in a substantially linear shape parallel to the curving direction (Y direction in FIG. 7). The plurality of signal wiring patterns 330 formed in a substantially linear shape parallel to the curving direction (Y direction in FIG. 7) can provide the shortest wiring length, which is suitable for transmitting a high-speed signal.

Reference numeral 340 denotes a reinforcing pattern made of a conductive material such as copper foil. The reinforcing pattern 340 is provided on the surface opposite to the surface on which the all-solid-state batteries 10 are mounted. The reinforcing pattern 340 has a substantially rectangular shape so as to surround the area where the all-solid-state batteries 10 are mounted.

Reference numeral 370 denotes a slit formed by a substantially rectangular opening penetrating the FPC 300. The slits 370 are provided on both sides of the area where the all-solid-state batteries 10 are mounted, in the curving direction (Y direction in FIG. 7). The slit 370 is larger than the reinforcing pattern 340 in the direction (X direction in FIG. 7) orthogonal to the curving direction.

Reference numeral 380 is a dividing slit (divider) provided between the area where the all-solid-state battery 10 and the power supply wiring pattern 320 are provided and the area where the signal wiring pattern 330 is provided. Part of the dividing slit 380 is connected to the slit 370. The dividing slit 380 and the slit 370 form the outer shape of the area of the FPC 300 on which the all-solid-state batteries 10 are mounted so as to have a substantially meandering shape along the power supply wiring pattern 320.

In this embodiment, the power supply wiring pattern 320 is electrically connected to the all-solid-state batteries 10 and provided on the surface of the FPC 300. The signal wiring pattern 330 is electrically disconnected from the all-solid-state battery 10, but provided on the surface of the FPC 300. The dividing slit 380 divides the area of the power supply wiring pattern 320 and the area of the signal wiring pattern 330 from each other. The reinforcer and weakener are provided in the area of the power supply wiring pattern 320.

Similar to the FPC 200 in the first embodiment, the FPC 300 is provided with a joint (not shown) and a joining member (not shown). As described above, the dividing slit 380 and the slit 370 form the outer shape of the area of the FPC 300 on which the all-solid-state batteries 10 are mounted so as to have a substantially meandering shape along the power supply wiring pattern 320. That is, when the FPC 300 is bent, no force is applied to the slits 370, so that the FPC 300 is not deformed in the curving direction (Y direction in FIG. 7) and twisted, so that the FTC 300 has flexibility as a whole. Thereby, the stress generated in the joint (not shown), the joining member (not shown), and the all-solid-state batteries 10 can be relieved. It is suitable for the FPC 300 when bent has a large curvature.

On the other hand, the stress concentration can be avoided in the area where the signal wiring pattern 330 is provided because it is curved with a uniform curvature when the FPC 300 is bent. The wiring length of the signal wiring pattern 330 can be minimized, and the signal quality can be improved. That is, when the FPC 300 is bent, the area where the all-solid-state batteries 10 and the power supply wiring pattern 320 are provided and the area where the signal wiring pattern 330 is provided can be bent differently. Thereby, desired functions can be obtained that are different for each area.

### Third Embodiment

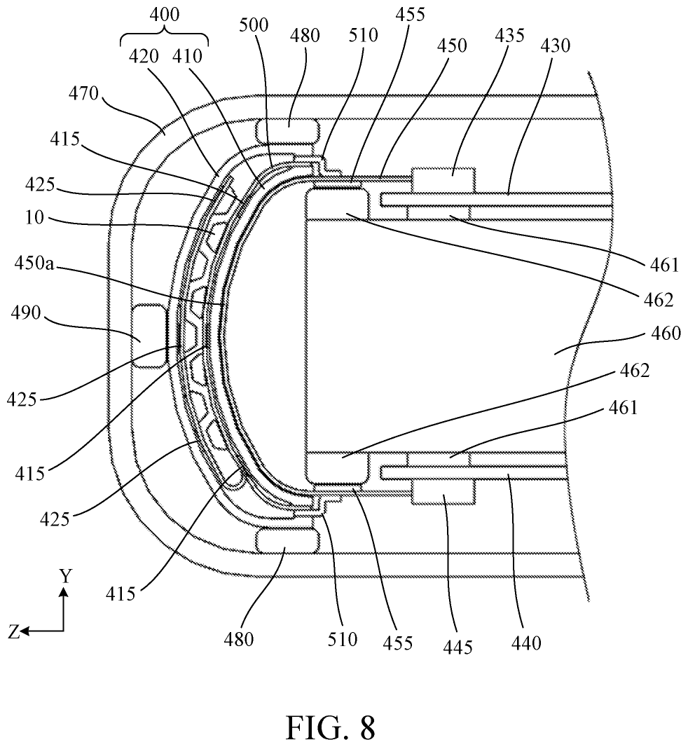

Referring now to FIG. 8, a description will be given of a retention case (retainer) 400 of the battery module according to a third embodiment of the present invention. For a simple description, only parts different from those of the first and second embodiments will be described. FIG. 8 is a structural diagram of the retention case 400 in this embodiment. FIG. 8 schematically illustrates a partially transparent state for clarity purposes. More specifically, the retention case 400 and an exterior cover 470 are made transparent so as to show the internal structure.

In FIG. 8, the retention case 400 includes a lower case 410 and an upper case 420 having a curved shape and made of a material such as resin for housing and retaining a battery substrate 500, which will be described later. The lower case 410 and the upper case 420 are fixed by screws (not shown) or the like.

The battery substrate 500 includes FPC having flexibility, and a plurality of all-solid-state batteries 10 are mounted (mounted) on the battery substrate 500. The battery substrate 500 is configured to relieve stress on the all-solid-state battery 10 as described in the first and second embodiments (or includes the reinforcer and weakener). The battery substrate 500 is attached to the lower case 410 by a lower tape 415 formed of an elastic adhesive tape or the like. The battery substrate 500 is attached to the upper case 420 by an upper tape 425 formed of an elastic adhesive tape or the like by being bent and inverted in the middle. At this time, the plurality of all-solid-state batteries 10 are alternated so as to face each other. In this embodiment, the outer shape of the all-solid-state battery 10 has a substantially trapezoidal shape. Thereby, the space can be saved and capacity can be increased. The exterior of the all-solid-state batteries 10 is made of an insulating material such as resin. Thereby, electrical short circuits can be reduced due to the contact between the all-solid-state batteries 10 and the contact between the all-solid-state batteries 10 and an exposed wiring pattern (not shown).

In this embodiment, the battery substrate 500 is bent and inverted in the middle, and the plurality of all-solid-state batteries 10 are alternated so as to face each other. However, the all-solid-state batteries 10 may be arranged without using the battery substrate 500. For example, the all-solid-state batteries 10 may be arranged by so-called housing wiring in which a wiring pattern (not shown) is formed on the lower case 410 and the upper case 420 by metal plating or the like. Thereby, the number of parts can be reduced and good assembly performance can be obtained.

The battery substrate 500 is provided with lead terminals (joining terminals) 510 for electrically connecting the battery substrate 500 and a connection FPC 450 at both ends. The lead terminal 510 is made of a conductive material such as metal, and its surface receives a metal plating treatment with copper (Cu), nickel (Ni), tin (Sn), etc., and can be soldered. One end of the lead terminal 510 is soldered to the battery substrate 500 and sandwiched between the lower case 410 and the upper case 420. The other end of the lead terminal 510 extends from the retention case 400 and is soldered to the connection FPC 450. In this embodiment, the battery substrate 500 and the connection FPC 450 are electrically connected via the lead terminals 510, but the battery substrate 500 and the connection FPC 450 may be directly and electrically connected to each other. More specifically, both ends of the battery substrate 500 may be extended from the retention case 400 and soldered to the connection FPC 450. This structure can reduce the number of parts and save space.

Reference numeral 430 denotes a first circuit board made of a PWB. Reference numeral 435 denotes a first connector that is reflow-soldered on the first circuit board 430. Reference numeral 440 is a second circuit board made of a PWB. Reference numeral 445 denotes a second connector that is reflow-soldered on the second circuit board 440.

Reference numeral 450 denotes the connection FPC for electrically connecting the first circuit board 430 and the second circuit board 440 to each other. The connection FPC 450 is made of FPC having flexibility, and its one end is fixed and held onto the first connector 435 and its other end is fixed and held onto the second connector 445. The connection FPC 450 is provided with a reinforcing plate 455 at a position corresponding to the lead terminal 510. The reinforcing plate 455 is made of a material such as glass epoxy and adhered and fixed onto the connection FPC 450. The connection FPC 450 has a curved part 450a having a curved surface shape in the assembly state into the electronic apparatus. The curved part 450a has a shape along the lower case 410 of the retention case 400. In this embodiment, a plurality of all-solid-state batteries 10 are mounted on the battery substrate 500, but a plurality of all-solid-state batteries 10 may be mounted on the connection FPC 450. More specifically, a plurality of all-solid-state batteries 10 are mounted on the connection FPC 450, and an area in which a plurality of all-solid-state batteries 10 are mounted is sandwiched between the lower case 410 and the upper case 420. This structure can reduce the number of components and save space.

Reference numeral 460 denotes a body made of a material such as resin or metal for attaching the first circuit board 430, the second circuit board 440, and the exterior cover 470. The body 460 has an attachment portion 461 for attaching the first circuit board 430 and the second circuit board 440. The first circuit board 430 and the second circuit board 440 are fixed onto the body 460 with screws (not shown) or the like via the attachment portion 461. The body 460 has a receiver 462 at a position corresponding to the lead terminal 510 and the reinforcing plate 455. The receiver 462 is provided with a slight gap from the reinforcing plate 455. More specifically, this gap is provided so that the receiver 462 and the reinforcing plate 455 do not interfere with each other in consideration of the attachment errors of the first circuit board 430 and the second circuit board 440 and the positioning errors of the connection FPC 450 relative to the body 460.

Reference numeral 470 denotes the exterior cover forming the housing of this embodiment made of a material such as resin or metal. The exterior cover 470 is fixed onto the body 460 with screws (not shown) or the like. Reference numeral 480 denotes a first elastic member made of an elastic material, and provided near the outer cover 470 in a direction (Y direction in FIG. 8) orthogonal to the insertion direction of the connection FPC 450 into the first connector 435 and the second connector 445 on both end sides of the retention case 400. The first elastic member 480 acts to absorb vibrations of the retention case 400 in the direction (Y direction in FIG. 8) orthogonal to the insertion direction into the first connector 435 and the second connector 445.

Reference numeral 490 denotes a second elastic member made of an elastic material, having a curved shape of the retention case 400, and provided near the outer cover 470 in the horizontal direction (Z direction in FIG. 8) and the insertion direction into the first connector 435 and the second connector 445 of the connection FPC 450. The second elastic member 490 acts to absorb vibrations of the retention case 400 in the horizontal direction (Z direction in FIG. 8) and the insertion direction into the first connector 435 and the second connector 445. The second elastic member 490 may be made of a material relatively softer than that of the first elastic member 480. More specifically, due to manufacturing errors in the length of the connection FPC 450, the retention case 400 is mispositioned in the horizontal direction (Z direction in FIG. 8) and the insertion direction into the first connector 435 and the second connector 445. At this time, the material and size of the second elastic member 490 are selected so that the positioning errors can be absorbed by the elastic deformations of the second elastic member 490. On the other hand, when the retention case 400 swings in the direction (Y direction in FIG. 8) orthogonal to the insertion direction into the first connector 435 and the second connector 445, stress is applied at the connectors (not shown) between the connection FPC 450 and the first connector 435 and the second connector 445. At this time, the material and size of the first elastic member 480 are selected so as to absorb vibrations by the elasticity of the first elastic member 480.

In the battery module according to this embodiment, the battery substrate 500 is the substrate having the flexibility in which a plurality of all-solid-state batteries 10 are mounted on one surface and curved with a predetermined curvature. The retention case 400 houses and retains the battery substrate 500 having the reinforcer and the weakener. The lead terminals 510 extend from both ends of the retention case 400. The retention case 400 may have a predetermined curvature (substantially the same curvature as that of the battery substrate 500).

As described above, in this embodiment, a plurality of all-solid-state batteries 10 are mounted on the battery substrate 500, and are housed and retained by the retention case 400. Thereby, the curved surface shape of the battery substrate 500 is maintained, so that the stress generated in the all-solid-state batteries 10 and the joint (not shown) of the all-solid-state batteries 10 can be relieved. The lead terminals 510 extending from the retention case 400 are provided at both ends of the battery substrate 500 mounted with the plurality of all-solid-state batteries 10, and are electrically connected to the connection FPC 450 by soldering. Thereby, the battery module can be conveniently used like a general-purpose battery pack.

### Fourth Embodiment

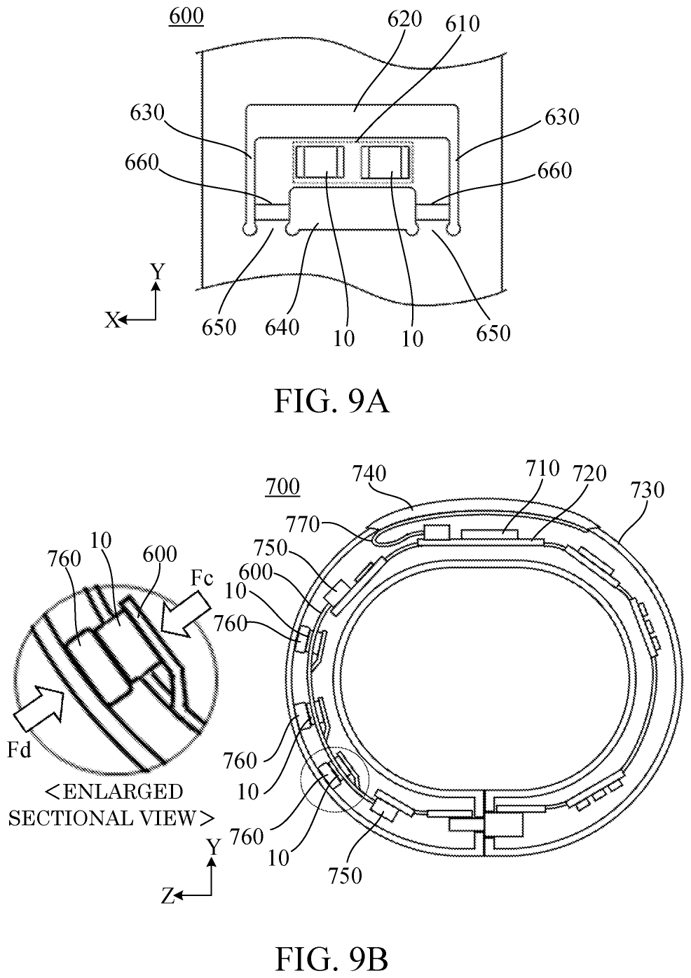

Referring now to FIGS. 9A and 9B, a description will be given of FPC substrate 600 according to a fourth embodiment of the present invention. For simple a simple description, only parts different from the first to third embodiments will be described. FIG. 9A is a structural diagram of the FPC 600 in this embodiment, and illustrates detailed cutout part of the FPC 600. FIG. 9A illustrates a pre-assembly plane state of the FPC 600, rather than a curved state of the FPC 600 incorporated into a wearable device 700, which will be described later. The curving direction of the FPC 600 incorporated into the wearable device 700 is the Y direction in FIG. 9A.

In FIG. 9A, a plurality of all-solid-state batteries 10 are mounted on the FPC 600. Reference numeral 610 denotes a reinforcing pattern made of a conductive material such as copper foil. The reinforcing pattern 610 is provided on the surface opposite to the surface on which the all-solid-state batteries 10 are mounted. Reference numeral 620 denotes a first slit that opens in a direction (X direction in FIG. 9A) orthogonal to the curving direction at a position distant from the area where the all-solid-state batteries 10 are mounted, by a predetermined distance in the curving direction (Y direction in FIG. 9A). Reference numeral 630 denotes a second slit that opens in a direction parallel to the curving direction (Y direction in FIG. 9A) from both ends of the first slit 620. Reference numeral 640 denotes a third slit that opens on the side opposite to the first slit 620 in the curving direction (Y direction in FIG. 9A) via the area on which the all-solid-state batteries 10 are mounted.

The area where the all-solid-state battery 10 is mounted is formed in a substantially U shape by the first slit 620, the second slit 630, and the third slit 640. Reference numeral 650 denotes a bending support provided at the substantially U-shaped end formed by the first slit 620, the second slit 630, and the third slit 640, and serves as a fulcrum in bending the area where the all-solid-state battery 10 is mounted. Reference numeral 660 is a coverlay opening provided near the bending support 650 and formed by opening part of a coverlay (not shown) of the FPC 600.

The FPC 600 has a bendable structure around the bending support 650 as a fulcrum in which the coverlay opening 660 promotes deformations when the area on which the all-solid-state battery 10 is mounted is pressed. At this time, since the reinforcing pattern 610 suppresses deformations of the area where the all solid state battery 10 is mounted, the stress generated in the all-solid-state battery 10 can be relieved.

FIG. 9B is a structural diagram of the wearable device 700 according to this embodiment. FIG. 9B schematically illustrates a partially transparent state for clarity purposes. More specifically, the exterior cover 730 is made transparent so as to show the internal structure.

In FIG. 9B, reference numeral 700 denotes the wearable device equipped with the FPC 600 illustrated in FIG. 9A, which is worn on the wrist by a user such as a smart watch. The FPC 600 is curved in a curved shape while incorporated in the wearable device 700. Reference numeral 710 denotes a control IC having a function of a central processing unit that controls the operation of each element in the wearable device 700. Reference numeral 720 denotes a control board on which an electric circuit for controlling the operation of the wearable device 700 is formed. The control board 720 is formed of a so-called rigid flexible board having a plurality of rigid areas and a plurality of flexible areas on one board. Reference numeral 730 denotes an exterior cover forming a housing of the wearable device 700, which is made of a thermoplastic elastomer or the like. The control board 720 is fixed to the exterior cover 730 with screws or adhesives (not shown). Reference numeral 740 denotes a display that is exposed from part of the exterior cover 730 and includes an OLED (Organic Light Emitting Diode) or the like to display information on the wearable device 700. The display 740 is electrically connected to the control board 720 by a connection FPC 770.

Reference numeral 750 denotes a connector for electrically connecting the FPC 600 to the control board 720. The connectors 750 are provided on both ends of the FPC 600 so that the FPC 600 is removable. That is, the control board 720 and the FPC 600 are configured as separate bodies. Thereby, it is user-friendly because it can be easily replaced when the all-solid-state battery 10 breaks down or when the capacity of the all-solid-state battery 10 is to be increased.

Reference numeral 760 denotes a buffer member (presser or bender) made of an elastic material and provided between the all-solid-state battery 10 and the exterior cover 730 at a position corresponding to the all-solid-state battery 10. An adhesive tape or the like is provided on the surface of the buffer member 760, and the exterior cover 730, the buffer member 760, and the all-solid-state battery 10 are adhered and fixed. The buffer member 760 acts to press the area where the all-solid-state battery 10 is mounted. At this time, as illustrated in the enlarged sectional view of FIG. 9B, the all-solid-state battery 10 is retained while an elastic force Fd of the buffer member 760 is balanced with a repulsive force Fc in which the area where the all-solid-state battery 10 is mounted tries to return to the original shape by the restoring force of the FPC 600. Thereby, shakes of the all-solid-state battery 10 caused by vibrations or the like are relieved, and the stress generated in the all-solid-state battery 10 can be alleviated.

In this embodiment, the buffer member 760 is configured to press the area where the all-solid-state battery 10 is mounted, but the exterior cover 730 may be configured to press the area where the all-solid-state battery 10 is mounted. More specifically, the exterior cover may have a convex shape, and an adhesive tape or the like is provided on the convex surface. This structure can reduce the number of components. The buffer member 760 corresponds to the bender configured to contact the all-solid-state battery 10 and to bend the FPC 200 with the bending support 650 serving as a fulcrum.

As described above, in this embodiment, the first slit 620 opens at a position distant from the all-solid-state battery 10 by a predetermined distance in a direction orthogonal to the curving direction of the FPC 600. The second slit 630 opens from both ends of the first slit 620 in a direction parallel to the curving direction of the FPC 600. The third slit 640 opens on the opposite side of the first slit 620 with respect to the all-solid-state battery 10 at a position distant from the all-solid-state battery 10 by a predetermined distance. The bending support 650 is provided at the end of the shape formed by the first slit 620, the second slit 630, and the third slit 640. The buffer member 760 contacts the all-solid-state battery 10 and bends the FPC 600 with the bending support 650 serving as a fulcrum.

As described above, the area where the all-solid-state battery 10 is mounted is formed in a substantially U shape by the first slit 620, the second slit 630, and the third slit 640. The reinforcing pattern 610 is provided on the surface opposite to the surface on which the all-solid-state battery 10 is mounted. The coverlay opening 660 is provided at and near the bending support 650. That is, when the area of the FPC 600 on which the all-solid-state battery 10 is mounted is pressed, the coverlay opening 660 promotes deformations and enables the FPC 600 to be bent around the bending support 650 serving as a fulcrum. At this time, the reinforcing pattern 610 suppresses the deformations of the area where the all-solid-state battery 10 is mounted. Thereby, the stress generated in the all-solid-state battery 10 can be relieved.

Each embodiment can provide an electronic apparatus and a battery module, each of which can reduce stress generated at a connector between an electric device and a substrate while the substrate having the flexibility is curved.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-048534, filed on Mar. 19, 2020 which is hereby incorporated by reference herein in its entirety.

What is claimed is:

1. An electronic apparatus comprising:
a substrate having flexibility and including a base material made of a thin film material;
a plurality of electric devices arranged on one surface of the base material and including a set of terminal electrodes;
a joint configured to electrically connect the terminal electrodes and the substrate via a conductive joining member;
a reinforcer provided on a surface of the base material opposite to a mount surface of each of the plurality of electric devices, and configured to reinforce a mount area of each electric device; and
a weakener configured to weaken a non-mount area in which each electric device is not mounted,
wherein the reinforcer includes a reinforcing pattern made of a conductive material, and
wherein the weakener has an opening that penetrates at least part of the substrate and the base material.

2. The electronic apparatus according to claim 1, wherein the weakener is provided at both ends of the mount area in the substrate in a predetermined direction.

3. The electronic apparatus according to claim 2, wherein the substrate includes a curved part curved with a predetermined curvature in an assembled state or a use state of the electronic apparatus, and
wherein the predetermined direction is a curving direction of the curved part.

4. The electronic apparatus according to claim 3, wherein the plurality of electric devices are arranged at predetermined intervals along the curving direction, and
wherein the reinforcer and the weakener are alternated along the curving direction.

5. The electronic apparatus according to claim 1, wherein the electric device includes an all-solid-state battery made by laminating a positive electroactive material, a solid electrolyte, and a negative electroactive material.

6. The electronic apparatus according to claim 2, wherein the reinforcer is larger than the joint in a direction orthogonal to the predetermined direction, and
wherein the weakener is distant from the joint by a predetermined distance, and larger than the reinforcer in the direction orthogonal to the predetermined direction.

7. The electronic apparatus according to claim 2, wherein the reinforcer includes a plurality of deformation suppressers, the deformation suppressor being provided for a corresponding one of the plurality of electric devices and configured to suppress a deformation of the mount area,
wherein the weakener includes a plurality of deformation promoters, the deformation promoter being provided for a corresponding one of the plurality of electric devices and configured to promote a deformation of the non-mount area,
wherein the plurality of deformation suppressers and the plurality of deformation promoters are alternated along the predetermined direction, and
wherein the electronic apparatus further comprises:
a wiring pattern electrically connected to at least one of the plurality of electric devices on a surface of at least one of the plurality of deformation promoters; and
a twist suppresser provided on a surface of one of the plurality of deformation promoters, which has no wiring pattern, the twist suppressor being divided from the wiring pattern, as large as the wiring pattern in a direction orthogonal to the predetermined direction, and configured to suppress a twist of the substrate.

8. The electronic apparatus according to claim 1, wherein the twist suppresser includes a dummy pattern.

9. The electronic apparatus according to claim 1, further comprising:
a first wiring pattern electrically connected to the electric devices and provided m a surface of the substrate;
a second wiring pattern electrically disconnected from the electric devices and provided on the surface of the substrate; and
a divider configured to divide an area of the first wiring pattern and an area of the second wiring pattern,
wherein the reinforcer and the weakener are provided in the area of the first wiring pattern.

10. The electronic apparatus according to claim 1, further comprising a retainer configured to house and retain the reinforcer and the weakener.

11. The electronic apparatus according to claim 2, further comprising:
a first slit that is distant from the electric device by a predetermined distance and opens in a direction orthogonal to the predetermined direction of the substrate;
a second slit that opens from each of both ends of the first slit in a direction parallel to the predetermined direction of the substrate;
a third slit that is distant from the electric devices by a predetermined distance and opens on a side opposite to the first slit with respect to the electric device;
a bending support provided at an end of a shape formed by the first slit, the second slit, and the third slit; and
a bender configured to contact the electric device and to bend the substrate with the bending support serving as a fulcrum.

12. A battery module comprising:
a plurality of all-solid-state batteries each made by laminating a positive electroactive material, a solid electrolyte, and a negative electroactive material;
a substrate having flexibility, mounted with the plurality of all-solid-state batteries on one surface, and curved with a predetermined curvature;
a retainer configured to house and retain the substrate; and
joining terminals extending from both ends of the retainer.

13. The battery module according to claim 12, wherein the retainer is formed with the predetermined curvature.
